(19) United States
(12) Patent Application Publication
(10) Pub. No.: US 2012/0243653 A1
(43) Pub. Date: Sep. 27, 2012

(54) CONTROL ROD FOR BOILING WATER REACTOR AND METHOD OF MANUFACTURING CONTROL ROD

(75) Inventors: Yu Kuwada, Hitachi (JP); Kazuki Kobayashi, Hitachi (JP); Norio Kawashima, Mito (JP); Koichi Machida, Hitachi (JP); Toraki Sakuma, Hitachi (JP); Takeshi Tsukamoto, Mito (JP); Hidekazu Takazawa, Hitachi (JP)

(73) Assignee: Hitachi-GE Nuclear Energy, Ltd.

(21) Appl. No.: 13/372,531

(22) Filed: Feb. 14, 2012

(30) Foreign Application Priority Data
Mar. 25, 2011 (JP) 2011-068904

(51) Int. Cl. G21C 7/10; G21C 21/18

(52) U.S. Cl. 376/327; 156/64

(57) ABSTRACT

A control rod has four blades, each of which has a rectangular cross section in a plane perpendicular to an axis of the control rod, disposed so as to form a cross-shaped cross section in the plane perpendicular to the axis. The blades include a plurality of aligned square tubes having a square cross section in a plane perpendicular to the axis and including a neutron absorber filling hole filled with neutron absorber, frame plates disposed parallel to the aligned square tubes in a direction perpendicular to a width direction of the blade, and on one side end and another side end of the blade in the width direction, respectively, and cover plates disposed along the width direction and sandwiching the aligned square tubes. Each blade has the aligned square tubes, the frame plates and the cover plates joined together as a single-piece construction by Hot Isostatic Pressing diffusion bonding.

### CLAIM OF PRIORITY

The present application claims priority from Japanese Patent application serial no. 2011-68904, filed on Mar. 25, 2011, the content of which is hereby incorporated by reference into this application.

### BACKGROUND OF THE INVENTION

1. Technical Field

The present invention relates to a control rod and a method of manufacturing a control rod and, in particular, to a control rod and a method of manufacturing a control rod suitable for applying to a boiling water reactor.

2. Background Art

A plurality of control rods are completely inserted in a core of a boiling water reactor at the time of operation shutdown of a boiling water reactor. This control rod has a cross-shaped cross section in a plane perpendicular to the axis, and is inserted among four fuel assemblies loaded in the core. The control rods are withdrawn from the core at start-up of the boiling water reactor. In rated power operation, all the control rods except for a plurality of control rods used for adjusting reactor power are completely withdrawn from the core. In the descriptions below, a hollow is referred to as a hollowed out hole having an open end and a closed end, a hole is referred to as a through-hole which penetrates through, and both of them are referred to as a hole as a collective term.

A control rod used in the boiling water reactor has four blades extending in four directions from a tie rod disposed in an axial center of the control rod. As the blade, there are a hole type blade made up of a plurality of tubular members or at least one plate member having a long narrow hole to be filled with neutron absorber, and a plate type blade made up of many layers or a flat plate containing neutron absorber.

The control rod having the hole type blade are as following:

In order to improve the pressure resistance of a neutron absorber rod and to increase the amount of neutron absorber, a control rod is proposed in which a blade is formed by horizontally aligning and joining a plurality of tubular members having a square cross section in a plane perpendicular to the axis (see Japanese Patent Laid-open No. 1(1989)-254895). Each tubular member is filled with neutron absorber. This control rod has rounded corner portions at four corners of each tubular member, a recess portion between the corner portions, and a wedge-shaped metal welding region between the tubular members for easy welding or for preventing damage or wear of the tubular members caused by contacting with a side surface of a channel box of the fuel assembly.

Other control rod having the hole type blade is disclosed in Japanese patent application publication No. 2002-533736. This control rod has four blades, each of which includes a flat plate and holes formed in the flat plate and filled with neutron absorber. The holes are formed in a horizontal direction or a vertical direction (see FIGS. 2a and 2d in Japanese patent application publication No. 2002-533736).

In addition, further other control rod having the hole type blade is disclosed in Japanese Patent Laid-open No. 2010-71791. This control rod has the blade that is formed by vertically welding and joining a plurality of separate stainless steel plates having a plurality of vertical holes to be filled with neutron absorber.

On the other hand, a control rod having the plate type blade is disclosed in Japanese Patent Laid-open No. 4(1992)-177198. In this control rod, in order to prevent the functional decline of the control rod itself caused by bending or detaching of a blade due to a difference in thermal expansion coefficient or thermal conductivity in the blade made up of a flat plate or multiple layers, it is proposed that a plurality of functional gradient materials having graded thermal expansion coefficients and thermal conductivities in the width direction of the blade and a neutron absorber of the blade in the center side of the control rod are superposed in an aligned manner and joined by thermal diffusion. In addition, an outside of a middle blade, which is joined by the thermal diffusion as above, exposed to coolant is covered with an outermost layer material including zirconium alloy having superior corrosion resistance, and the outermost layer material and the middle blade are joined by thermal diffusion.

Recently, it has been recognized that a degradation phenomenon in the structural member of a control rod is presumably caused by irradiation assisted stress corrosion cracking (IASCC). A case example is disclosed in a report of Nuclear and Industrial Safety Agency at the Ministry of Economy, Trade, and Industry, titled “Regarding the disclosure of investigation report on a crack and the like in a hafnium type control rod in a boiling water nuclear power plant” dated on May 31, 2006, and also in a separately supplemented “Investigation report (summary) on a crack and the like in a hafnium type control rod in a boiling water nuclear power plant”. In addition, general technical description with regard to the IASCC phenomenon is disclosed in “A review of irradiation assisted stress corrosion cracking”, by P. Scott et al., Journal of Nuclear Materials 211 (1994), pages 101-122.

### CITATION LIST

### Patent Literature

[Patent Literature 1] Japanese Patent Laid-open No. 1(1989)-254895
[Patent Literature 2] Japanese Patent application publication No. 2002-533736
[Patent Literature 3] Japanese Patent Laid-open No. 2010-71791
[Patent Literature 4] Japanese Patent Laid-open No. 4(1992)-177198

### Non Patent Literature

[Non Patent Literature 1] “Regarding the disclosure of investigation report on a crack and the like in a hafnium type control rod in a boiling water nuclear power plant” by Nuclear and Industrial Safety Agency at the Ministry of Economy, Trade, and Industry, dated on May 31, 2006, and separately supplemented “Investigation report (summary) on a crack and the like in a hafnium type control rod in a boiling water nuclear power plant”.
[Non Patent Literature 2] “A review of irradiation assisted stress corrosion cracking”, P. Scott et al., Journal of Nuclear Materials 211 (1994), pages 101-122.
[Non Patent Literature 3] Peter E. Price et al. “Hot Isostatic Pressing of Metal Powders”, Metals Handbook Ninth Edition Volume 7 Powder Metallurgy (1984), pages 419, 424 and 425.

### SUMMARY OF THE INVENTION

### Technical Problem

As described in “A review of irradiation assisted stress corrosion cracking”, P. Scott et al., Journal of Nuclear Materials 211 (1994), pages 101-122, it is considered that the IASCC occurs when three factors of neutron irradiance, applied stress, and environmental conditions are superimposed at the same time. The neutron irradiance in a control rod used in a boiling water reactor, in general, tends to increase from the lower end to the upper end portion of a tie rod in the axial direction of the control rod. It is considered that a cause for the occurrence of continuous applied stress may be the effect of residual stress associated with welding work at the time of manufacturing the control rod. As for the environment conditions, a structure such that a plurality of structural members of the control rod are facing each other and an extremely narrow gap in coolant inside the core, that is, a creviced environment is formed between the structural members facing each other, is considered to be possibly related to IASCC.

The control rod disclosed in FIG. 2a of Japanese Patent application publication No. 2002-533736 is provided with a blade which is made of a stainless steel plate having a plurality of side holes to be filled with neutron absorber, thus no creviced environment containing coolant is formed at least in the blade. For this reason, the control rod disclosed in FIG. 2a of Japanese Patent application publication No. 2002-533736 is considered as having a less probability of IASCC occurrence caused by the formation of a creviced environment. In this control rod, however, open ends of all the side holes must be closed by welding after neutron absorber is filled in the side holes to prevent the neutron absorber from spilling out. A problem in this control rod is that since a welding portion is formed in an upper portion of the control rod where neutron irradiance becomes high due to neutron irradiation during a long term, a probability of IASCC occurrence in the welding portion of the upper portion of the control rod is increased when the environment is worsened by, for example, increasing of dissolved oxygen concentration in coolant coming in contact with the control rod. Furthermore, as a result, since the side holes for storing neutron absorber are disposed in the vicinity of the welding portion, if the IASCC occurs in the welding portion, coolant flows into a space inside the side holes, and a probability of creating a secondary damage may be increased by coolant evaporation or a chemical reaction between the coolant and the neutron absorber.

The control rod disclosed in FIG. 2d of Japanese Patent application publication No. 2002-533736 has a stainless steel plate forming a plurality of vertical holes to be filled with neutron absorber. In this case, welding is not required to close each open end of the plurality of vertical holes at the upper end portion of the control rod where neutron irradiance is high, as in the control rod disclosed in FIG. 2a of Japanese Patent application publication No. 2002-533736; however, the vertical holes must be formed over an active length of neutron absorber storage, which requires a long machining time in conventional machining, and unfortunately, machining accuracy may not be maintained.

In the control rod disclosed in Japanese Patent Laid-open No. 1(1989)-254895, a welding portion is formed in the wedge-shaped metal welding region located in the upper portion of the control rod where irradiance becomes high, thus, as explained in FIG. 2a of Japanese Patent application publication No. 2002-533736, a probability of the IASCC occurrence in the welding portion in the upper portion of the control rod is increased. In addition, since the rounded corner portions are formed to the four corners of each tubular member included in the control rod and the recess portions are formed between the corner portions, if the IASCC occurs in the wedge-shaped metal welding portion, coolant flows into the recess portion between the corner portions. Consequently, a creviced environment containing coolant is formed in the recess portion into which the coolant flows, increasing the occurrence of secondary IASCC caused by the creviced environment.

In the control rod disclosed in FIG. 1 of Japanese Patent Laid-open No. 2010-71791, a blade is formed by vertically welding and joining a plurality of stainless steel plates having a plurality of vertical holes to be filled with neutron absorber. The length of the vertical holes to be formed by machining can be shortened in this disclosed technology, so machining accuracy can be maintained to some extent. However, there is a problem that a welding portion is required in the upper portion of the control rod where neutron irradiance is high.

The life of a control rod includes a nuclear life, for which a limit is set in accordance with a decrease in the neutron absorption capacity of neutron absorber as operation continues, and a mechanical life, for which a limit is set in accordance with the mechanical strength of material used in the control rod against a load applied to the control rod at the time of scram or earthquake, or against a stress generated in the structural materials by the pressure of helium generated when boron carbide is used as neutron absorber; the life of a control rod is said to be the shorter one of the two. A conventional control rod mainly uses SUS316L or SUS304L as a material having a superior IASCC resistance, and its mechanical life is determined by the mechanical strength of these materials. The nuclear life can be extended by increasing the amount of neutron absorber stored in a blade. However, there is a maximum allowable value for the thickness of the blade in order to maintain smooth insertability of the control rod, thus, when a space for storing neutron absorber is increased, the thickness of the structural material surrounding the space will be decreased. That is, the nuclear life and the mechanical life, in general, are in a trade-off relationship with each other. In order to extend both lives together, a high-strength material may be used; however, there is a problem that a material must be selected in consideration of the IASCC resistance in a conventional control rod.

A first object of the present invention is to provide a control rod or a method of manufacturing a control rod that can prevent irradiation assisted stress corrosion cracking in a hole type blade having a long narrow hole to be filled with neutron absorber.

A second object of the present invention is to provide a control rod or a method of manufacturing a control rod that can reduce manufacturing cost in a hole type blade having a long narrow hole to be filled with neutron absorber.

Furthermore, a third object of the present invention is to provide a control rod or a method of manufacturing a control rod that can further extend its life.

### Solution to Problem

The feature of the present invention for accomplishing the above object is a control rod for a boiling water reactor comprising four blades, each of which has a rectangular cross section in a plane perpendicular to an axis of the control rod, disposed so as to form a cross-shaped cross section in the plane perpendicular to the axis,

wherein each blade includes a plurality of square tubes, which are aligned, having a square cross section in a plane perpendicular to the axis and including a neutron absorber filling hole filled with neutron absorber; frame plates disposed parallel to the aligned square tubes in a direction perpendicular to a width direction of the blade, and on one side end and another side end of the blade in the width direction, respectively; and cover plates disposed along the width direction and sandwiching the aligned square tubes; and

wherein each blade has the aligned square tubes, the frame plates and the cover plates joined together as a single-piece construction by Hot Isostatic Pressing diffusion bonding.

It is desirable that the blade has the aligned square tubes disposed parallel to the axis of the control rod.

Furthermore, it is desirable that part of the aligned square tubes is extended to an upper end portion of the blade and a plenum portion is formed in the neutron absorber filling hole.

It is desirable that interior diameter of the neutron absorber filling hole is at least 80% of thickness of the blade, and length of the neutron absorber filling hole is at least 34 times width of the blade.

Additionally, it is desirable that the blade has the square tubes disposed perpendicular to the axis of the control rod.

It is desirable that the square tube has a square cross section in a plane perpendicular to the axis, and has a single neutron absorber filling hole.

Furthermore, it is desirable that the square tube has a plurality of neutron absorber filling holes.

It is desirable that a high-strength material is used for the square tubes and an IASCC resistant material is used for the frame plates and the cover plates.

Furthermore, it is desirable that a control rod having four blades, each of which has a rectangular cross section in a plane perpendicular to an axis of the control rod, disposed so as to form a cross-shaped cross section in the plane perpendicular to the axis; and an upper support member attached to an upper end portion of the blade,

wherein each blade includes a plurality of plate members or square tubes, which are aligned, having a neutron absorber filling hole filled with neutron absorber, and extending part of the plurality of tubular members or plate members to the upper support member; and

wherein a plenum portion is formed in the neutron absorber filling hole.

The feature of the present invention is a method of manufacturing a control rod comprising steps of:

aligning a plurality of square tubes having a square cross section in a plane perpendicular to an axis of the square tube and a neutron absorber filling hole to be filled with neutron absorber;

disposing frame plates parallel to the aligned square tubes in a direction perpendicular to a width direction of the aligned square tubes, and on both side ends of the aligned square tubes in the width direction;

disposing cover plates sandwiching the aligned square tubes, along the width direction;

forming a blade by joining each square tube included in the aligned square tubes, the frame plates and the cover plates together as a single-piece construction by Hot Isostatic Pressing diffusion bonding;

filling the neutron absorber filling hole with the neutron absorber; and

closing the neutron absorber filling holes formed in the aligned square tubes by attaching a lower support member to a lower end portions of the aligned square tubes after the filling of the neutron absorber.

### Advantageous Effect of the Invention

The present invention can provide a control rod or a method of manufacturing a control rod that can prevent irradiation assisted stress corrosion cracking in a hole type blade having a long narrow hole to be filled with neutron absorber.

Moreover, the present invention can provide a control rod or a method of manufacturing a control rod that can reduce manufacturing cost in a hole type blade having a long narrow hole to be filled with neutron absorber.

Furthermore, the present invention can provide a control rod or a method of manufacturing a control rod that can further extend its life.

### BRIEF DESCRIPTION OF THE DRAWINGS

FIG. 1 is a perspective view showing a control rod according to embodiment 1, which is a preferred embodiment of the present invention, applied to a boiling water reactor.

FIG. 2 is a perspective view showing a blade shown in FIG. 1.

FIG. 3 is a cross-sectional view taken along A-A line of FIG. 2.

FIG. 4 is a perspective view showing a blade of a control rod according to embodiment 4, which is another embodiment of the present invention, applied to a boiling water reactor.

FIG. 5 is a cross-sectional view taken along B-B line of FIG. 4.

FIG. 6 is a perspective view showing a blade of a control rod according to embodiment 5, which is another embodiment of the present invention, applied to a boiling water reactor.

### DETAILED DESCRIPTION OF THE PREFERRED EMBODIMENTS

Embodiments of the present invention will be described below with reference to figures.

### Embodiment 1

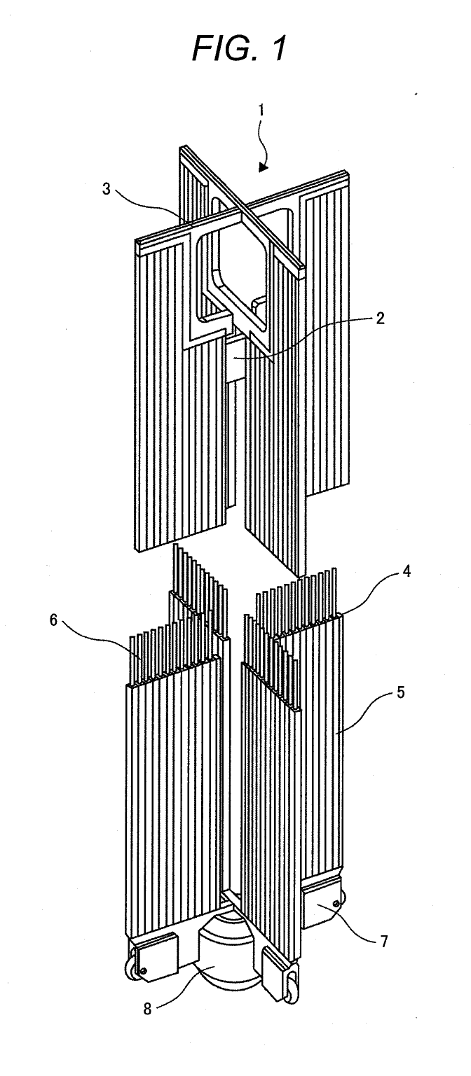

A control rod for a boiling water reactor according to embodiment 1, which is a preferred embodiment of the present invention, will be described with reference to FIGS. 1 to 3.

A control rod 1 of the present invention having a cross-shaped horizontal cross section is provided with an upper support member 3, four blades 5 having a plurality of neutron absorber filling holes 4 filled with neutron absorber 6, a center bridge 2 for joining the four blades, a lower support member 7 attached to a lower end portion of the blades 5 for supporting the blades 5, and a lower connector 8. The four blades 5 are extended in four directions from an axial center of the control rod 1. FIG. 1 shows the control rod in a vertically divided manner to illustrate a relationship between the neutron absorbers 6 and the neutron absorber filling holes 4.

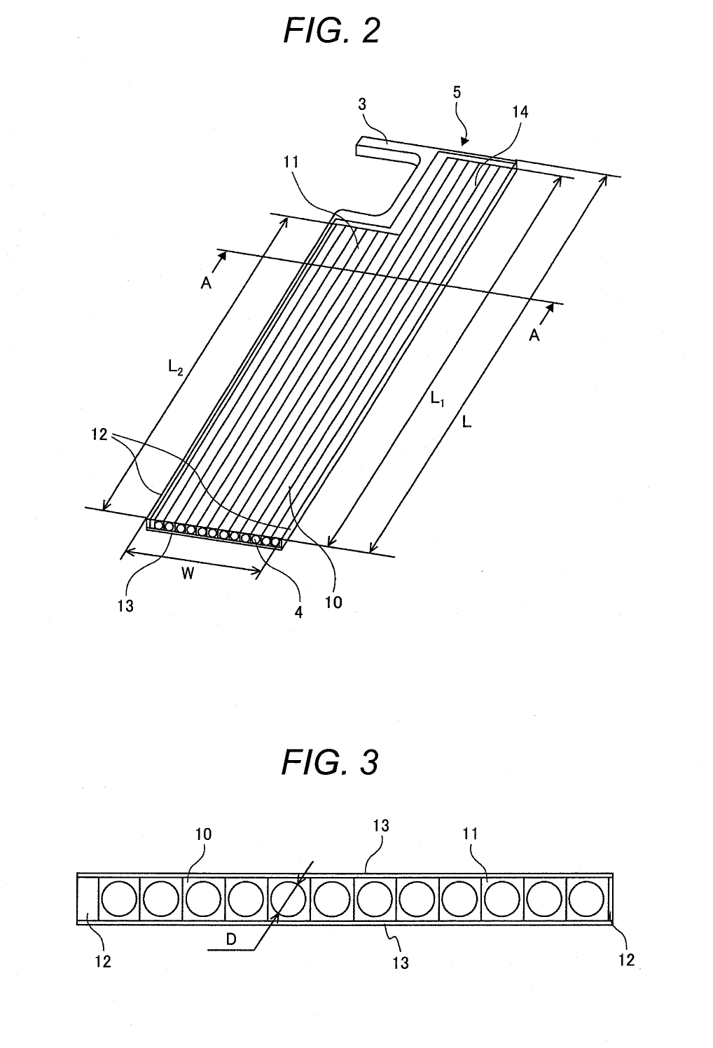

FIG. 2 is a perspective view showing the blade 5 shown in FIG. 1, and FIG. 3 is a cross-sectional view taken along A-A line of FIG. 2. Each blade 5 has a plurality of square tubes 10, a plurality of square tubes 11, frame plates 12 and cover plates 13. The square tubes 10 and 11 have a square cross section without any corner portion and recess portion and have a through-hole with a hole diameter D. This through-hole is the neutron absorber filling hole 4 to be filled with the neutron absorber 6, and in embodiment 1, is a vertical hole when the control rod is constructed. In the blade 5, the square tubes 10 and square tubes 11 are aligned from the axial center of the control rod 1. The square tubes 11 are disposed the axial center side of the control rod 1 from a position in which the square tubes 10 are disposed in the blade 5. The square tubes 10, as shown in FIG. 2, extend to a plenum portion 14 to be described later, but the square tubes 11 do not extend to the plenum portion 14. The plenum portion 14 is formed in the neutron absorber filling hole 4 formed in the square tubes 10, and is not formed in the neutron absorber filling hole 4 formed in the square tubes 11. The square tubes 10 and 11 are different in length in an axial direction of the control rod 1 but they have the same structure. The upper support member 3 is attached to upper end portions of the square tubes 10 and square tubes 11, respectively. The lower support member 7 is attached to lower end portions of the square tubes 10 and square tubes 11, respectively. Each neutron absorber filling holes 4 formed in the square tubes 10 and square tubes 11 is filled with neutron absorber 6.

The frame plates 12 are disposed parallel to the aligned square tubes 10 and 11 in a direction perpendicular to a width direction of the aligned square tubes 10 and 11, that is, a width direction of the blade 5, respectively. The frame plates 12 are disposed on one side end of the aligned square tubes 10 and 11, which is positioned on the axial center side of the control rod 1 and another side end of the aligned square tubes 10 and 11, which is positioned on an opposite side of the one side end. The one side end of the aligned square tubes 10 and 11 is one side end of the blade 5 in the width direction. Another side end of the aligned square tubes 10 and 11 is another side end of the blade 5 in the width direction. The cover plates 13 are disposed parallel each other in the width direction of the blade 5 and cover over the both sides of the square tubes 10 and 11 aligned in the width direction of the blade 5, respectively. The square tubes 10 and square tubes 11 that are aligned are disposed between the frame plates 12, and between the cover plates 13.

The aligned square tubes 10 and 11, the frame plates 12 and the cover plates 13 are joined together as a single-piece construction.

The control rod 1 is manufactured as follows:

The plurality of square tubes 10 and the plurality of square tubes 11 are aligned on one cover plate 13 from the axial center of the control rod 1 in the width direction of the blade 5 and disposed parallel to an axis of the control rod so as to place the upper end portions of the square tubes toward the upper support member 3. After the square tubes 10 and 11 are aligned on the one cover plate 13, the frame plates 12 put on the one cover plate 13 are disposed on the one side end and another side end of the aligned square tubes 10 and 11. The upper support member 3 is disposed on each upper end of the square tubes 10 and 11 and the frame plates 12. Another side of the square tubes 10 and 11 aligned in the width direction and put on the one cover plate 13 is covered with another cover plate 13. As a consequence, the cover plates 13 cover over on the both sides of the square tubes 10 and 11 aligned in the width direction, and the aligned square tubes 10 and 11 are surrounded with the frame plates 12 and cover plates 13. Then, each square tube included in the aligned square tubes, the upper support member 3, the frame plates 12 and the cover plates 13 are joined together as a single-piece construction by Hot Isostatic Pressing diffusion bonding. The Hot Isostatic Pressing diffusion bonding is disclosed in Peter E. Price et al. “Hot Isostatic Pressing of Metal Powders”, Metals Handbook Ninth Edition Volume 7 Powder Metallurgy (1984), pages 419, 424 and 425. The blade 5 is manufactured by the above single-piece construction. The blade 5 shown in FIG. 2 is manufactured by filling each neutron absorber filling hole 4 formed in the single-piece construction with the neutron absorber 6 from a lower end of the single-piece construction, and then, closing the lower end portion of the single-piece construction by end cover welding. Next, the control rod 1 is completed by welding the blades 5 to the center bridge 2, the lower support member 7, and the lower connector 8 connecting to the lower support member 7 so as to form a cross-shaped cross section in a plane perpendicular to the axis.

The square tubes 10 disposed in the plenum portion 14 in the blade edge side of the upper support member 3-side are provided with deeper neutron absorber filling holes 4 reaching to the plenum portion 14 compared to the square tubes 11. That is, the plenum portion 14 is formed in the neutron absorber filling hole 4. In FIG. 2, L1 shows length of the square tubes 10 and L2 shows length of the square tubes 11. The square tubes 10 are filled with the neutron absorbers 6 corresponding to the length L2, and the square tubes 11 are also filled with the neutron absorbers 6 corresponding to the length L2. As a result, the plenum portion 14 having a length of L1-L2 is formed in the upper support member 3-side of the square tubes 10. The plenum portion 14 is a hollow portion where the neutron absorbers are not filled in the neutron absorber filling holes 4.

The plenum portion 14 can store helium gas generated in the neutron absorber filling holes 4 by ¹⁰B (n, α)7Li reaction when boron carbide is used as the neutron absorber in the upper blade edge portion of the control rod in which the neutron irradiance becomes high, thus the hollow portion relaxes limits on mechanical strength against the pressure of the helium gas (internal pressure in the neutron absorber filling holes 4) in the neutron absorber filling holes 4 and functions to extend its mechanical life.

The hole diameter D of the above-described neutron absorber filling hole 4 in the center of the square cross section is at least 80% of the length of a side of the square. Ratios of the lengths L1 and L2 of the square tubes 10 and 11 to the hole diameter D, i.e., L1/D and L2/D are both at least 500. A ratio L/W of the blade length L to the blade width W in the blade 5 is at least 34.

According to embodiment 1, the blade 5 shown in FIG. 2 is constructed in such a way that the neutron absorber filling holes 4 are formed as vertical holes in a solid plate made of a plurality of square tubes joined together as the single-piece construction by the Hot Isostatic Pressing diffusion bonding, and the neutron absorbers 6 are filled in the neutron absorber filling holes 4 so that a creviced environment containing coolant (reactor water) is not formed in the blade 5. Thus, in the blade 5, a probability of IASCC occurrence due to the creviced environment can be significantly reduced.

In addition, according to embodiment 1, the blades 5 shown in FIG. 2 are welded to the upper support member 3, the lower support member 7, and the center bridge 2 so as to form a cross-shaped cross section in a plane perpendicular to the axis, but since there is no welding portion for closing the neutron absorber filling holes 4 in the upper portion of the blade 5 where neutron irradiance becomes high, a probability of IASCC occurrence due to a welding portion is reduced and no secondary damage is likely to occur by coolant entering into the neutron absorber filling hole 4.

Moreover, in conventional machining, a long machining time is required and machining accuracy cannot be maintained in order to form numerous neutron absorber filling holes in a plate-shaped blade. However, according to embodiment 1, a through-hole is machined in the square tube one by one and a plurality of the square tubes are joined together by the Hot Isostatic Pressing diffusion bonding, so that the machining time can be reduced, machining accuracy can be maintained, and furthermore, manufacturing cost can be reduced.

Additionally, according to embodiment 1, some neutron absorber filling holes 4 are extended to the plenum portion 14 to leave the extended portions hollow so that helium gas generated by ¹⁰B (n, α) 7Li reaction when boron carbide is used as neutron absorber can be stored in the plenum portion 14 to relax limits on the mechanical strength against the pressure of the helium gas and to extend its mechanical life.

This structure of the neutron absorber filling holes 4 extended to the plenum portion 14 can be applied not only to the control rod having the square tubes but also to a control rod having a hole type blade made up of a plurality of tubular members or a plurality of plates having long narrow holes filled with neutron absorber, for example, to a control rod, which is described in Japanese Patent Laid-open No. 1(1989)-254895, having corner portions and a recess portions between the corner portions, or to control rods, which is described in Japanese Patent application publication No. 2002-533736 and Japanese Patent Laid-open No. 4(1992)-177198, having a plurality of vertical holes to be filled with neutron absorber in divided plates divided in the vertical direction of a plate-shaped blade.

Even if tubular members provided with rounded corner portions at the four corners and a recess portions between the corner portions as disclosed in the Japanese Patent Laid-open No. 1(1989)-254895 are aligned for HIP diffusion bonding in place of the square tubes, the Hot Isostatic Pressing diffusion bonding will not be successful because the tubular members could deform due to the corner portions and the recess portions between the corner portions.

### Embodiment 2

A control rod according to embodiment 2, which is another embodiment of the present invention, will be described. In the control rod of the present embodiment, the cover plates 13 and the frame plates 12 used in embodiment 1 shown in FIG. 3 are applied with an IASCC resistant material such as SUS316L and SUS304L, and the square tubes 10 and 11 are applied with a high-strength material prioritizing strength over resistance such as SUS316 and GXM1. In other words, the IASCC resistant material is used only for the control rod surface exposed to coolant, and the high-strength material is used for the portion not exposed to the coolant because the control rod of the present embodiment can eliminate a creviced structure containing coolant. GXM1 or zircaloy may be used as a material for all. The other structure of the control rod of the present embodiment is the same as the control rod 1 of embodiment 1.

Each effect achieved in embodiment 1 can be obtained in the present embodiment. According to embodiment 2, the mechanical strength of the control rod interior not exposed to coolant can be increased while the IASCC resistance of the control rod surface exposed to the coolant is maintained, thus the strength against a load applied to the control rod at the time of scram insertion or earthquake can be increased.

In addition, embodiment 2 can increase the strength against the pressure of helium gas generated in the neutron absorber filling holes 4 by ¹⁰B (n, α) 7Li reaction when boron carbide is used as neutron absorber.

Furthermore, embodiment 2 can extend the mechanical life of the control rod by increasing the mechanical strength against the load or the pressure.

These effects allow using the IASCC resistant material only for the control rod surface exposed to coolant and eliminating a creviced structure containing coolant from the control rod, making it possible to provide a method which allows improving the IASCC resistance and the strength of the control rod and extending its life at the same time.

### Embodiment 3

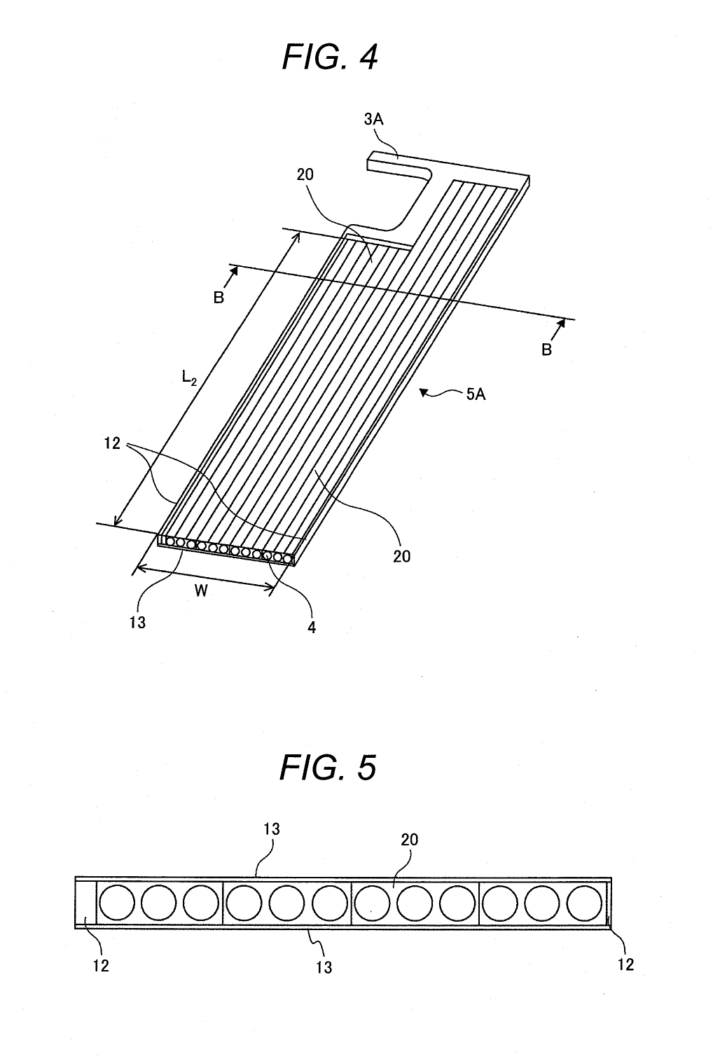

A control rod for a boiling water reactor according to embodiment 3, which is another embodiment of the present invention, will be described with reference to FIGS. 4 and 5.

FIG. 4 is a perspective view of a blade 5A corresponding to FIG. 2 of embodiment 1, and FIG. 5 is a cross-sectional view taken along B-B line of the blade 5A corresponding to FIG. 3 of embodiment 1. The control rod of the present embodiment is different from the control rod 1 of embodiment 1 in that, as shown in FIG. 5, the blade 5A is constructed by aligning not single-holed square tubes in FIG. 3 but a plurality of square tubes 20 which are a plate having a plurality of neutron absorber filling holes 4. In the present embodiment, an upper support member 3A is used. The other structure of the control rod of the present embodiment is the same as the control rod 1 of embodiment 1. In the present embodiment, each square tube 20 included in the aligned square tubes 20, the frame plates 12 and the cover plates 13 are also joined together as a single-piece construction by Hot Isostatic Pressing diffusion bonding. The blade 5A is also manufactured by the above single-piece construction.

Each effect achieved in embodiment 1 can be obtained in the present embodiment. According to embodiment 3, the square tubes 10 and 11 no longer need to be prepared in large numbers, thus the present embodiment can contribute to cost reduction by decreasing the number of parts.

### Embodiment 4

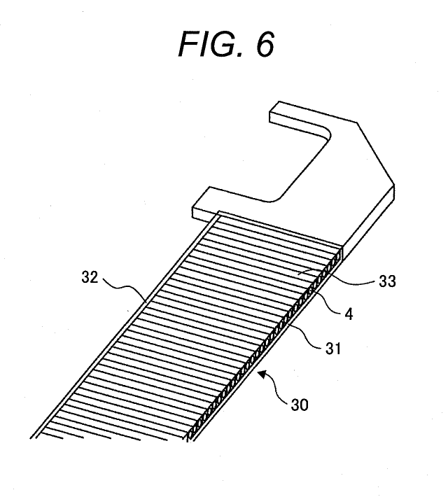

A control rod for a boiling water reactor according to embodiment 4, which is another embodiment of the present invention, will be described with reference to FIG. 6.

The control rod of the present embodiment has four blades 30, as shown in FIG. 6. In the blade 30, a plurality of square tubes 33 having at least one neutron absorber filling hole 4 are aligned horizontally with respect to a blade 30, and after disposing frame plates 32 to an axial center side of the square tubes 33 and cover plates 31 (only the lower plate is shown in FIG. 6) to the top and the bottom in the plate thickness direction of the square tubes 33. Then, each square tube 33 included in the aligned square tubes 33, the frame plates 31 and the cover plates 13 are also joined together as a single-piece construction by Hot Isostatic Pressing diffusion bonding. The blade 30 is also manufactured by the above single-piece construction.

Each effect achieved in embodiment 1 can be obtained in the present embodiment. According to embodiment 4, the structure shown in FIG. 6 is manufactured by Hot Isostatic Pressing diffusion bonding so that the conventional problems such as machining requiring long time or machining accuracy not being maintained can be solved, thus machining time can be reduced compared to a conventional control rod having horizontal holes.

Furthermore, as described in embodiment 2, the cover plates 31 and the frame plates 32 may be applied with an IASCC resistant material such as SUS316L and SUS304L, and the square tubes 33 with a high-strength material such as SUS316 and GXM1.

Because of this, embodiment 4, in the same manner as in embodiment 2, can increase the mechanical strength of the control rod interior not exposed to coolant while maintaining the IASCC resistance of the control rod surface exposed to the coolant. Therefore, the strength against a load applied to the control rod at the time of scram insertion or earthquake can be increased. In addition, when boron carbide is used as the neutron absorber, the strength against the pressure of helium gas generated in the neutron absorber filling holes 4 by ¹⁰B (n, α) 7Li reaction can be increased.

According to embodiment 4, the mechanical strength against the load or the pressure can be increased in such way to extend the mechanical life of the control rod.

As above, in embodiment 4, an IASCC resistant material can be used only for the control rod surface exposed to coolant, a creviced structure containing coolant can be eliminated, and improvements in the IASCC resistance and the strength of the control rod and extension of its life can be achieved at the same time.

In the embodiments described above, the square tube is provided with a through-hole; however, it may be a deep hollow having an open end and a closed end.

### REFERENCE SIGNS LIST

1: control rod, 2: center bridge, 3, 3A: upper support member (vertical hole), 4: neutron absorber filling hole, 5, 5A: blade (vertical hole), 6: neutron absorber, 7: lower support member, 8: lower connector, 10, 11: square tube (single tube), 12, 12A: frame plate (vertical hole), 13: cover plate (vertical hole), 20: square tube (a plurality of tube), 30: blade (horizontal hole), 31: cover plate (horizontal hole), 32: frame plate (horizontal hole), 33: square tube (horizontal hole).

What is claimed is:

1. A control rod for a boiling water reactor comprising:
four blades, each of which has a rectangular cross section in a plane perpendicular to an axis of the control rod, disposed so as to form a cross-shaped cross section in the plane perpendicular to the axis,
wherein each blade includes a plurality of square tubes, which are aligned, having a square cross section in a plane perpendicular to the axis and including a neutron absorber filling hole filled with neutron absorber; frame plates disposed parallel to the aligned square tubes in a direction perpendicular to a width direction of the blade, and on one side end and another side end of the blade in the width direction, respectively; and cover plates disposed along the width direction and sandwiching the aligned square tubes; and
wherein each blade has the aligned square tubes, the frame plates and the cover plates joined together as a single-piece construction by Hot Isostatic Pressing diffusion bonding.

2. The control rod for a boiling water reactor according to claim 1, wherein the blade has the square tubes disposed parallel to the axis of the control rod.

3. The control rod for a boiling water reactor according to claim 2, wherein part of the aligned square tubes is extended to an upper end portion of the blade and a plenum portion is formed in the neutron absorber filling hole.

4. The control rod for a boiling water reactor according to claim 2, wherein interior diameter of the neutron absorber filling hole is at least 80% of thickness of the blade, and length of the neutron absorber filling hole is at least 34 times width of the blade.

5. The control rod for a boiling water reactor according to claim 1, wherein the blade has the square tubes disposed perpendicular to the axis of the control rod.

6. The control rod for a boiling water reactor according to claim 2, wherein the square tube has a square cross section in a plane perpendicular to the axis and has one said neutron absorber filling hole.

7. The control rod for a boiling water reactor according to claim 2, wherein the square tube has a plurality of said neutron absorber filling holes.

8. The control rod for a boiling water reactor according to claim 1, wherein a high-strength material is used for the square tubes and an IASCC resistant material is used for the frame plates and the cover plates.

9. The control rod for a boiling water reactor according to claim 8, wherein the high-strength material is SUS316 or GXM1 and the IASCC resistant material is SUS316L or SUS304L.

10. A control rod for a boiling water reactor comprising:
four blades, each of which has a rectangular cross section in a plane perpendicular to an axis of the control rod, disposed so as to form a cross-shaped cross section in the plane perpendicular to the axis; and an upper support member attached to an upper end portion of the blade,
wherein each blade includes a plurality of plate members or square tubes, which are aligned from the axis of the control rod, having a neutron absorber filling hole filled with neutron absorber, and extending part of the plurality of tubular members or plate members to the upper support member; and
wherein a plenum portion is formed in the neutron absorber filling hole.

11. The control rod for a boiling water reactor according to claim 10,
wherein the tubular member has a square cross section in a plane perpendicular to the axis; and each blade includes frame plates disposing both side ends of the aligned tubular members or plate members and sandwiching the aligned tubular members or plate members, and has the aligned square tubes and the frame plates joined together as a single-piece construction by Hot Isostatic Pressing diffusion bonding.

12. The control rod for a boiling water reactor according to claim 11, wherein the blade includes cover plates sandwiching the aligned square tubes in a thickness direction the blade, and has the single-piece construction including the aligned square tubes, the frame plates, and the cover plates joined together by Hot Isostatic Pressing diffusion bonding.

13. The control rod for a boiling water reactor according to claim 11, wherein the blade has the square tubes disposed parallel to the axis of the control rod.

14. The control rod for a boiling water reactor according to claim 12, wherein the blade has the square tubes disposed parallel to the axis of the control rod.

15. A method of manufacturing a control rod for a boiling water reactor, comprising steps of:
aligning a plurality of square tubes having a rectangular cross section in a plane perpendicular to an axis of the square tube and a neutron absorber filling hole to be filled with neutron absorber;
disposing frame plates parallel to the aligned square tubes in a direction perpendicular to a width direction of the aligned square tubes, and on both side ends of the aligned square tubes in the width direction;
disposing cover plates sandwiching the aligned square tubes, along the width direction;
forming a blade by joining each square tube included in the aligned square tubes, the frame plates and the cover plates together as a single-piece construction by Hot Isostatic Pressing diffusion bonding;
filling the neutron absorber filling hole with the neutron absorber;
closing the neutron absorber filling holes formed in the aligned square tubes by attaching a lower support member to a lower end portions of the aligned square tubes after the filling of the neutron absorber; and
connecting four the blades, in which the neutron absorber filling holes were filled with the neutron absorber and closed, disposed in a shape of a cross, each other.

16. The method of manufacturing a control rod for a boiling water reactor according to claim 15, wherein in the step for aligning, the square tubes are disposed parallel to the axis of the control rod.

17. The method of manufacturing a control rod for a boiling water reactor according to claim 15, wherein in the step for aligning, the square tubes are disposed perpendicular to the axis of the control rod.

18. The method of manufacturing a control rod for a boiling water reactor according to claim 16, comprising step of:
forming the plurality of the neutron absorber filling holes in each square tube.

19. The method of manufacturing a control rod for a boiling water reactor according to claim 15, comprising steps of:
making the square tubes of a high-strength material; and
making the frame plates and the cover plates of an IASCC resistant material.

20. The method of manufacturing a control rod for a boiling water reactor according to claim 15, comprising step of:
making the square tubes, the frame plates, the cover plates, and the upper support member of GXM1 or zircaloy.
